(19) United States
(12) Patent Application Publication
(10) Pub. No.: US 2012/0222771 A1
(43) Pub. Date: Sep. 6, 2012

(54) ON-SITE MANUFACTURING OF COMPOSITE PIPELINE

(75) Inventors: Raymond N. BURKE, Cypress, TX (US); Nicholas J. VENERO, Clinton, NY (US)

(73) Assignee: PIPESTREAM B.V., Rijswijk (NL)

(21) Appl. No.: 13/040,505

(22) Filed: Mar. 4, 2011

(51) Int. Cl. F16L 9/14; B65H 81/00; B29C 63/10

(52) U.S. Cl. 138/140; 156/187; 156/428; 156/431

(57) ABSTRACT

Systems and methods for onsite manufacture of a composite pipeline. In one embodiment, a method for constructing a pipeline includes arranging a plurality of sections of tubing at or near to a location where the pipeline is to be finally installed. An end of a first of the sections of tubing axially abuts an end of a second of the sections of tubing. The abutting ends of the first and second of the sections of tubing are joined. A continuous strip of material is wrapped in a helical pattern over the length of the joined first and second of the sections of tubing to form a pipeline segment.

### BACKGROUND

Extensive pipeline systems have been constructed for carrying gas or liquid under pressure over long distances. Pipeline construction is a costly and labor intensive process that generally includes stringing the pipe joints along the right of way where the pipeline is to be deployed, welding the pipe joints together, and coating the pipe joints, or at least the welds, to prevent corrosion.

Composite pipe provides numerous advantages over the steel pipe generally used to construct oil and gas pipelines. A length of composite pipe can be substantially lighter than the equivalent steel pipe resulting in reduced handling costs and increased safety. A composite may also be lower in cost and exhibit greater corrosion resistance and burst strength than an equivalent steel pipe. Therefore, improved techniques for constructing pipelines using composite pipe are desirable.

### SUMMARY OF DISCLOSED EMBODIMENTS

A composite pipeline and systems and methods for manufacturing composite pipeline at a pipeline installation site are disclosed. In one embodiment, a method for constructing a pipeline includes arranging sections of tubing near a location where the pipeline is to be finally installed. An end of a first of the sections of tubing axially abuts an end of a second of the sections of tubing. The abutting ends of the first and second of the sections of tubing are joined. A continuous strip of material is wrapped in a helical pattern over the length of the joined first and second of the sections of tubing to form a pipeline segment.

In another embodiment, a system for constructing a pipeline includes sections of liner tubing, a positioning apparatus, a joining apparatus, and a wrapping apparatus. The positioning apparatus is configured to arrange the sections of liner tubing end-to-end near a location where the pipeline is to be finally installed. The joining apparatus is configured to axially bond the sections of liner tubing into a tubing segment. The wrapping apparatus configured to helically wrap a strip of material around the joined sections of tubing to form a pipeline segment. The wrapping apparatus is configured to build the wall of the pipeline segment to a desired thickness while moving longitudinally along the pipeline segment.

In yet another embodiment, a method for on-site manufacture of composite pipeline, includes aligning axially, near a location of pipeline final installation, multiple metallic tubes. The tubes are welded together to form a tubing segment. A coiling mechanism is propelled longitudinally along the tubing segment. A metallic strip is unwound from a spool and wound in a spiral over the length of the tubing segment as the coiling mechanism longitudinally travels along the tubing segment.

In a further embodiment, an on-site manufactured composite pipeline includes liner tubes and continuous strips of material. The liner tubes are welded together end-to-end to form a tubing segment. The strips of material are each helically wrapped around the plurality of liner tubes. The strips of material increase the burst strength of a circumferential wall of the tubing segment.

In a yet further embodiment, a pipeline is constructed by a method including providing a liner tubes near a final installation location of the pipeline. The liner tubes are arranged to be longitudinally coaxial. The liner tubes are bonded lengthwise. The bonded liner tubes are strengthened by wrapping a strip of material helically about the circumference of the bonded liner tubes over the length of the bonded liner tubes.

### BRIEF DESCRIPTION OF THE DRAWINGS

For a more detailed description of the embodiments, reference will now be made to the following accompanying drawings:

FIG. 1 is an isometric view of a pipeline wrapping apparatus in accordance with one embodiment;

FIG. 2 is an isometric view of the pipeline wrapping apparatus shown in FIG. 1 after placement on a pipeline in accordance with one embodiment;

FIG. 3 is an end view of a pipeline wrapping apparatus in accordance with one embodiment;

FIG. 4 is an isometric view of the pipeline wrapping apparatus shown in FIG. 3;

FIG. 5A is a bottom view of a movement assembly for the pipeline wrapping apparatus in accordance with one embodiment;

FIG. 5B is a side view of the movement assembly shown in FIG. 5A;

FIGS. 5C and 5D are detailed views of portions of the movement assembly shown in FIG. 5A;

FIG. 6 is a side view of a wrapped section of pipeline in accordance with one embodiment.

FIG. 7 is flow diagram for a method for manufacturing a composite pipeline near to the location of final installation of the pipeline in accordance with various embodiments;

FIG. 8 is a view of stringing liner tubes as part of a composite pipeline manufacturing operation in accordance with various embodiments;

FIG. 9 is a view of welding liner tubes as part of a composite pipeline manufacturing operation in accordance with various embodiments;

FIG. 10A is a view of wrapping the liner tubing segment as part of a composite pipeline manufacturing operation in accordance with various embodiments;

FIG. 10B shows a composite pipeline manufacturing operation using a pipeline wrapping apparatus supported by a rail system in accordance with various embodiments;

FIG. 11 is a view of coating a composite pipeline segment as part of a composite pipeline manufacturing operation in accordance with various embodiments;

FIG. 12 is a view of a tapered ended added to a composite pipeline segment as part of a composite pipeline manufacturing operation in accordance with various embodiments;

FIG. 13 is a view of a composite pipeline segment being positioned at a deployment location in accordance with various embodiments;

FIG. 14 is a view of a longitudinal cross-section of a composite pipe segment constructed in accordance with various embodiments.

### DETAILED DESCRIPTION OF THE DISCLOSED EMBODIMENTS

In the drawings and description that follows, like parts are marked throughout the specification and drawings with the same reference numerals. The drawing figures are not necessarily to scale. Certain features of the invention may be shown exaggerated in scale or in somewhat schematic form and some details of conventional elements may not be shown in the interest of clarity and conciseness. The invention is subject to embodiments of different forms. Some specific embodiments are described in detail and are shown in the drawings, with the understanding that the disclosure is to be considered an exemplification of the principles of the invention, and is not intended to limit the invention to the illustrated and described embodiments. The different teachings of the embodiments discussed below may be employed separately or in any suitable combination to produce desired results. The terms “connect,” “engage,” “couple,” “attach,” or any other term describing an interaction between elements is not meant to limit the interaction to direct interaction between the elements and may also include indirect interaction between the elements described. The various characteristics mentioned above, as well as other features and characteristics described in more detail below, will be readily apparent to those skilled in the art upon reading the following detailed description of the embodiments, and by referring to the accompanying drawings.

While composite pipe provides numerous advantages over conventional steel pipe, construction of pipelines using composite pipe have generally employed the same techniques applied to steel pipe. The present disclosure presents methods and systems for constructing a pipeline using composite pipe wherein the composite pipe is manufactured as a pipeline segment of indefinite length at or near the location where the pipeline is to be finally installed. The disclosed apparatus and techniques are applicable to various pipe diameters, and provide reduced construction cost while providing a pipeline that is lighter and stronger than that produced using conventional methods. At least some embodiments of the present disclosure employ a pipeline wrapping apparatus at the pipeline installation site to manufacture composite pipeline.

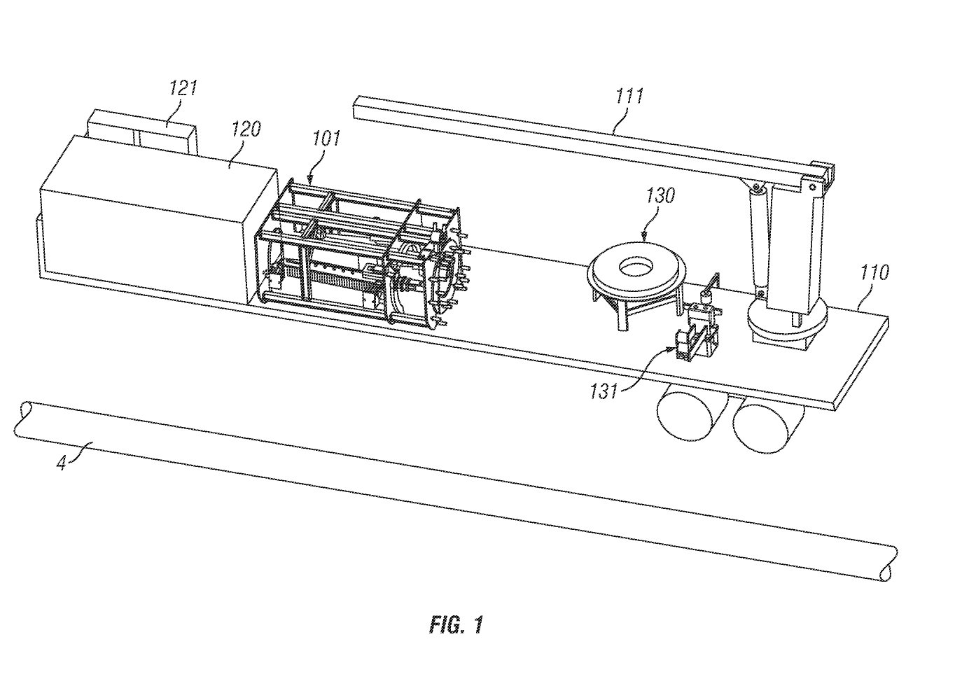

In FIG. 1, a pipeline wrapping apparatus 101 in accordance with embodiments disclosed herein is shown. The wrapping apparatus 101 is configured for on-site manufacture of composite pipeline. The pipeline wrapping apparatus 101 may be transported on a trailer 110 to a location where pipeline is to manufactured and deployed. The trailer 110 may include a crane 111 to place the pipeline wrapping apparatus 101 at selected locations along a pipeline segment. To allow for the operation of the pipeline wrapping apparatus 101 in remote locations, the trailer 110 may further include a generator 120 to provide electrical power to the pipeline wrapping apparatus 101 and a control unit 121. One or more spools 130 of a strip material 133 may be disposed on the trailer. A feeding arm 131 for feeding the strip from the spool 130 to the pipeline wrapping apparatus 101 may also be included. The strip material 133 may be, for example, a continuous strip of martensitic steel or low carbon steel with a corrosion protection coating.

Various non-metallic materials may also be used for the strip material 133. For example, the strip material 133 may be a thermoplastic, such as polybutylene terephthalate or polypropylene, or a thermoset resin, such as polyester, polyurethane, vinylester, or epoxy. The non-metallic material may be reinforced with glass or other fibers. Thermoplastics and thermoset resins may be produced using pultrusion, which provides a continuous process of producing a substantially constant cross-section. As part of the pultrusion process, the non-metallic material may be reinforced with the fibers while being formed into the strip material 133. The resulting strip material 133 may be wound onto a spool for use with embodiments of the present disclosure.

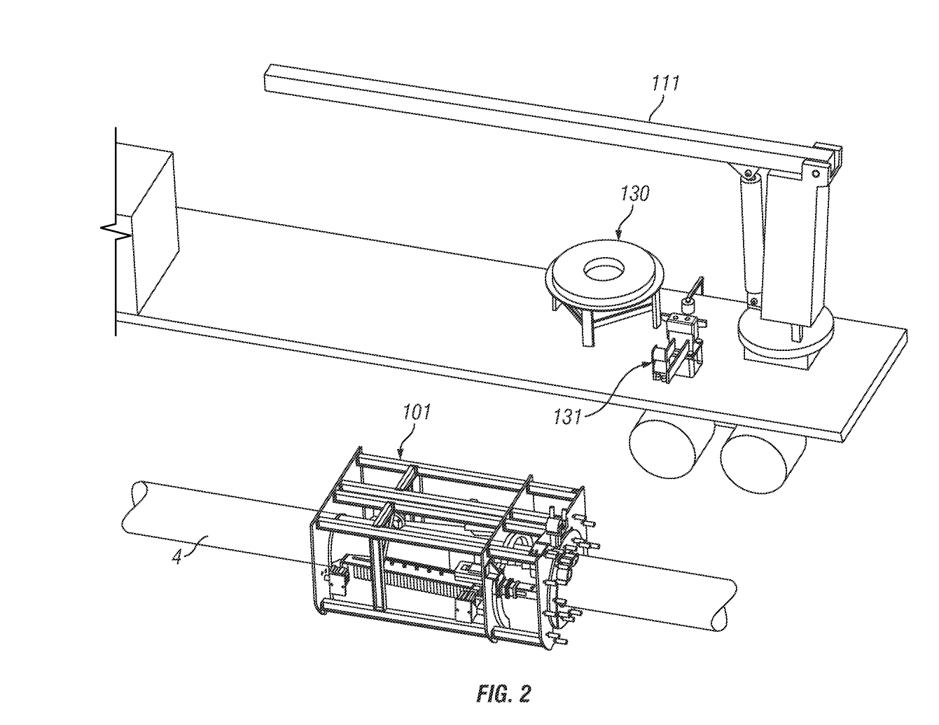

FIGS. 2-4 show the pipeline wrapping apparatus 101 after placement onto the pipeline segment 4. The pipeline segment 4 may be composed of unwrapped or wrapped tubing. The pipeline wrapping apparatus 101 is placed onto the pipeline segment 4 using the crane 111. A frame 300 of the pipeline wrapping apparatus 101 has an opening 340 that is sufficiently wide to receive the pipeline segment 4. A winding head 301, which wraps the strip material around the pipeline segment 4, includes a removable portion 341 that is sufficiently wide to receive the pipeline segment 4. After placement onto the pipeline segment 4, removable portion 341 is reattached to the winding head 301 to fully surround the pipeline 4.

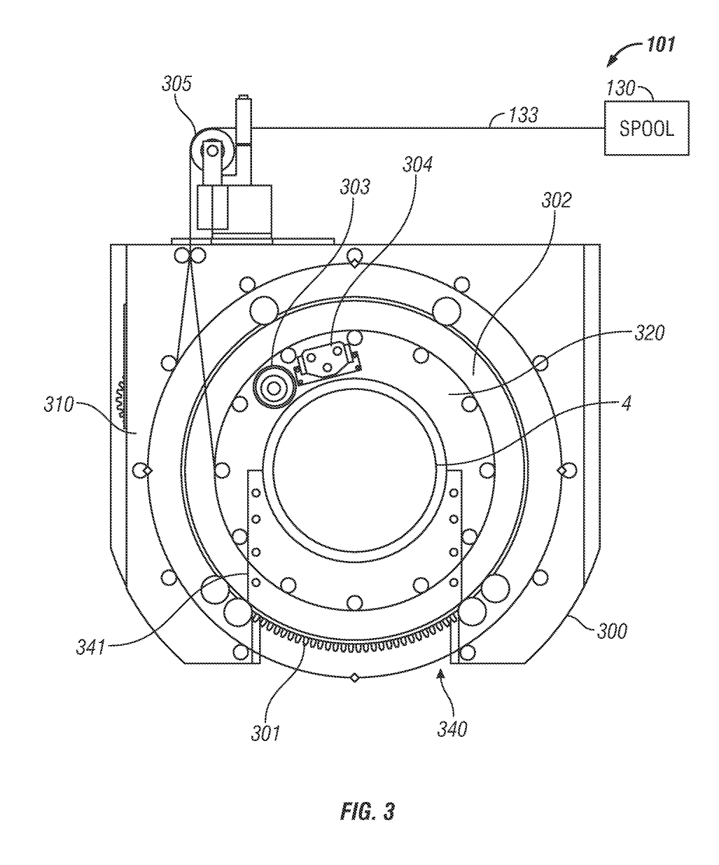

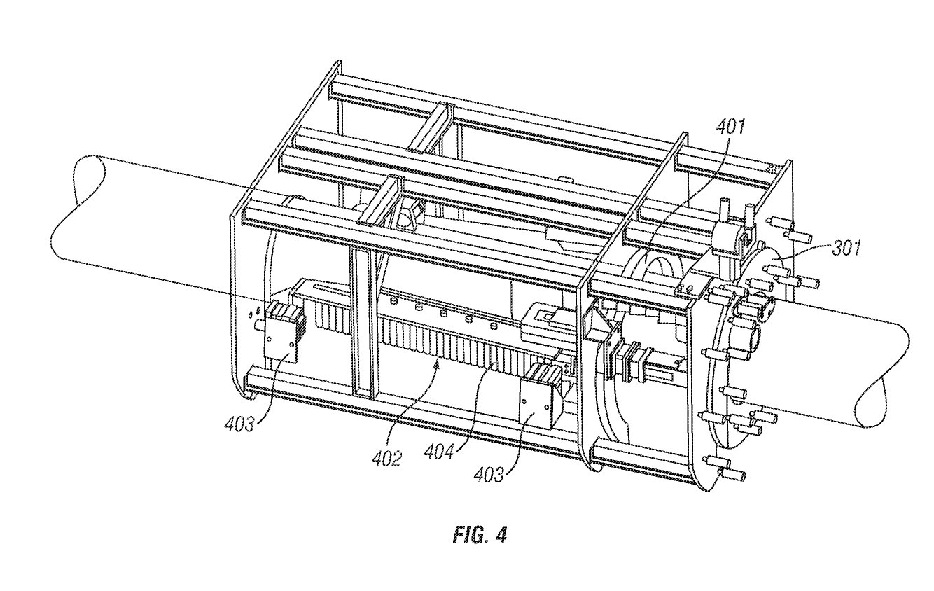

With reference to FIGS. 3 and 4, the operation of reinforcing the wall of a pipeline segment under construction may be carried out by feeding the strip material 133 from the spool 130 to the pipeline wrapping apparatus 101. The strip 133 is fed down from roller 305 onto a carrying roll 302. Going, in the orientation shown in FIGS. 3 and 4, counterclockwise around carrying roll 302, the strip 133 is threaded through a turnaround roll 303 and a preform assembly 304, which is configured to bend the strip 133 into a diameter close to the diameter of the pipeline segment 4. The end 320 of the strip 133 may then be affixed to the outside of the pipeline segment 4 using, for example, a quick setting adhesive, a mechanical clamp, or welding.

After affixing the end 320 of the strip 133, wrapping the strip 133 around the pipeline segment 4 is carried out by the winding head 301. As the winding head 301 winds the strip around the pipeline segment 4, additional strip 133 is wrapped around carrying roll 302. Each rotation of the winding head 301 adds another layer of strip 133 to the carrying roll 302, which accumulates strip 133 faster than what is wrapped onto pipeline 4 because of the greater diameter. The carrying capacity (indicated by circle 310) of the carrying roll 302 may be selected such that after half of the strip 133 from spool 130 is wrapped onto the pipeline 4, the remaining half of the strip 133 is carried by the carrying roll 302.

The winding head 301 moves axially relative to the pipeline segment 4 during rotating in order to helically wrap the strip 133 around the pipeline segment 4. The entire pipeline wrapping apparatus 101 may be movable relative to the pipeline segment 4 by attaching one or more track assemblies to the pipeline segment 4. In one embodiment shown in FIG. 4, a movement assembly 402 is used to move the pipeline wrapping apparatus 101 axially relative to the pipeline 4 during rotation of the winding head 301.

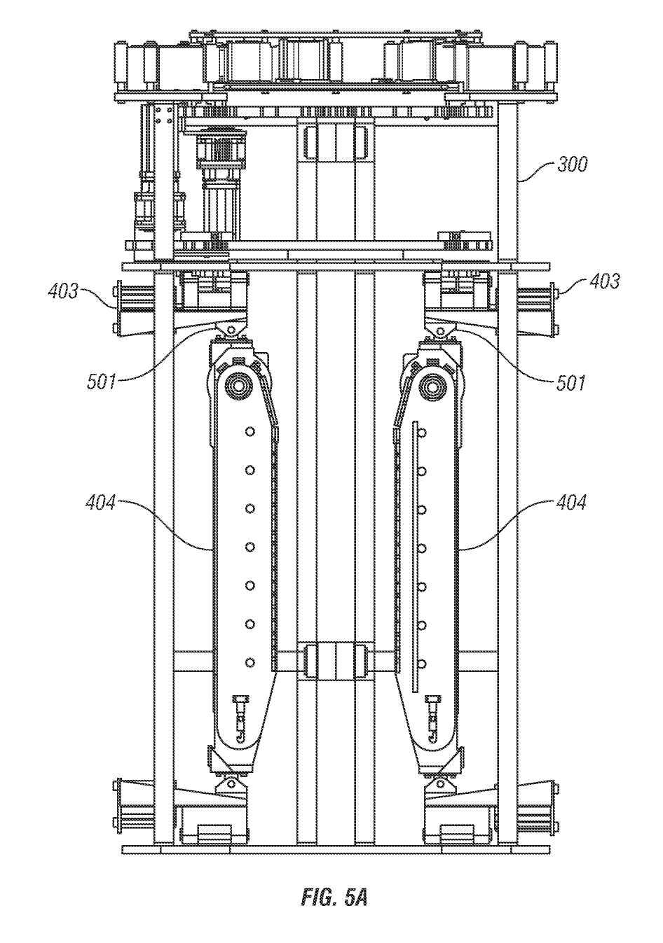

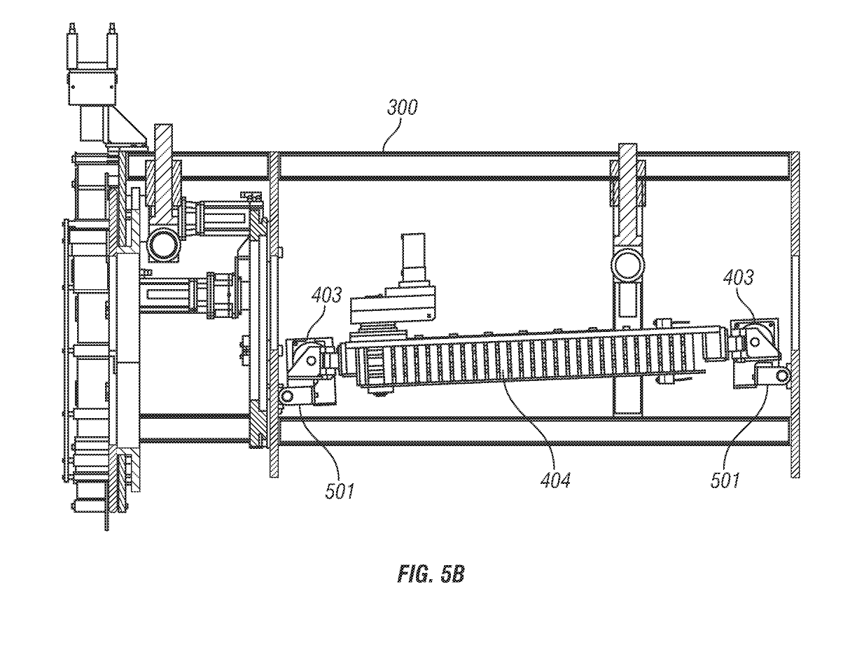

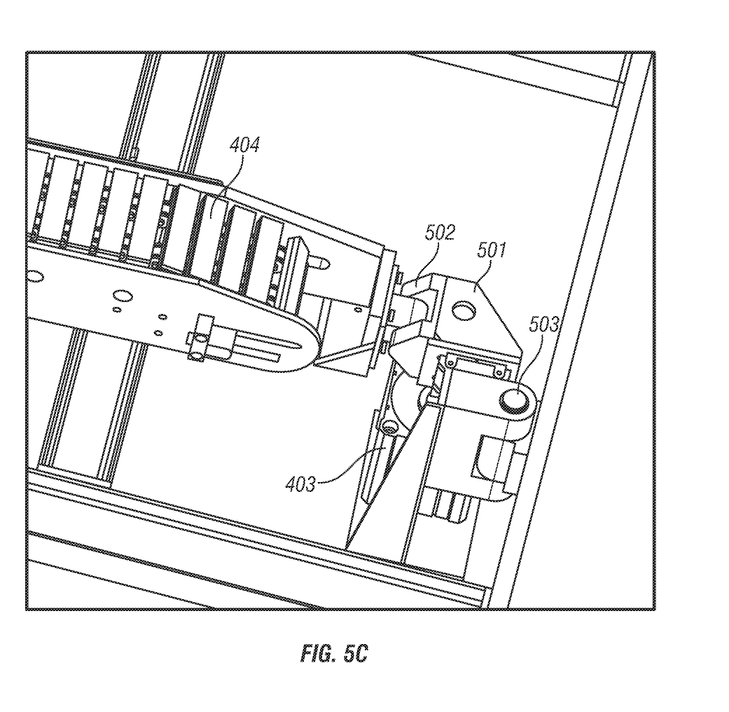

The movement assembly 402, which is shown in greater detail in FIGS. 5A-5D, includes a track 404, which actuates in a manner similar to treads on a tank or other tracked vehicle. The movement assembly 402 also includes cylinders 403 on opposing ends of the track 404, which may be pneumatic, hydraulic, or electrically actuated. The cylinders 403 press the ends of the track 404 against the pipeline segment 4 to provide sufficient frictional force such that movement of the track 404 causes the pipeline wrapping apparatus 101 to move axially relative to the pipeline segment 4. Another track 404 and cylinders 403 may be provided on the opposite side of the pipeline segment 4 to balance the track 404 and cylinders 403 visible in FIG. 4. Each track 404 may be mounted on a pivoting anchor 501 that allows the tracks 404 to be tilted along the axis of the pipeline segment 4 to control the radial position of the pipeline wrapping apparatus 101 around the pipeline 4. The pivoting anchor 501 may be attached to the tracks 404 with a pivot 502 and to the frame 300 with a pivot 503, as best shown in FIGS. 5C and 5D. Cylinders 403 may be attached to the tracks 404 indirectly through the pivoting anchor 501.

The movement assembly 402 illustrated in detail in FIGS. 5A-5D allows for torque to be applied to the pipeline segment 4, which counteracts torque from the winding head 301 as it wraps the pipeline segment 4. The alignment of the tracks 404 relative to the axis of the pipeline 4 can be adjusted to maintain the orientation of the pipeline wrapping apparatus 101 on the pipeline during the wrapping process. Increasing the angle of the tracks 404 relative to the axis of the pipeline segment 4 increases the amount of torque applied to the pipeline 4 by the tracks 404. The desired angle of the tracks 404 varies, in part, according to the conditions of the exterior of the pipeline segment 4.

The pipeline wrapping apparatus 101 may further include an oscillating adhesive assembly 401 that applies adhesive to the pipeline segment 4 before the strip 133 is wound onto the pipeline segment 4. The adhesive may be provided in tanks (not shown) to a metering pump (not shown) that applies a selected amount of adhesive to the pipeline segment 4. The rotational rate of the winding head 301 may govern the volume flow rate of adhesive from the metering pump in order to provide a more precise amount of adhesive to the pipeline segment 4. Examples of adhesives that may be used to adhere the strip 133 to the pipeline 4 include liquid epoxies, paste epoxies (single and multi-part), acrylics (e.g., methacrylate), polyurea, phenolic, and anaerobic and polyurethane adhesives.

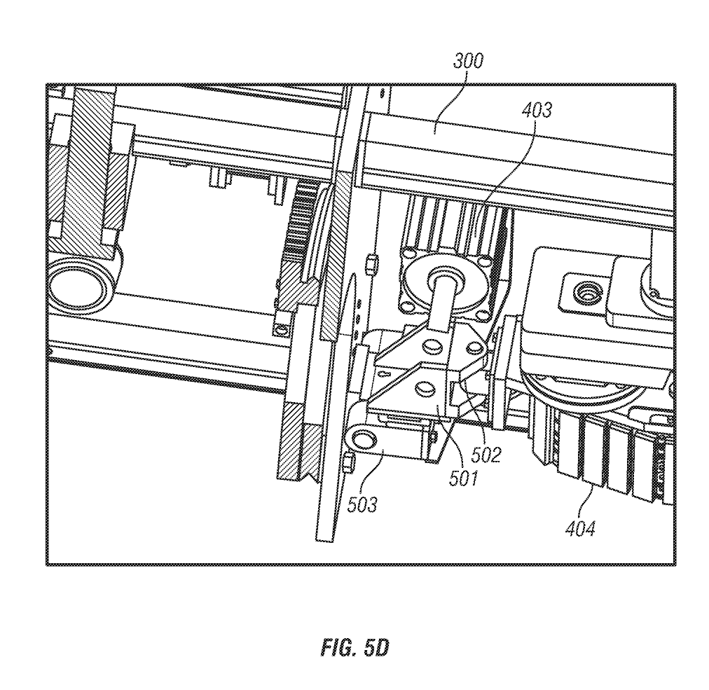

An example of a pipeline segment 4 with walls reinforced in accordance with embodiments disclosed herein is shown in FIG. 6. In this embodiment, the pipeline segment 4 is helically wrapped with two successive layers 2, 3 of the strip material 133. The pipeline wrapping apparatus 101 shown in FIGS. 3 and 4 may be used to apply both layers 2, 3. The axial movement provided by the movement assembly 402 may be timed with the rotation rate of the winding head 301 in order to control the angle of the layers 2, 3 and a gap 5 between the successive wrap of the strip. To apply the first layer 3, the pipeline wrapping apparatus 101 is axially translated along the pipeline segment 4 while the winding head rotates. The coordinated axial translation and winding continues for a selected length of the pipeline segment 4, which may be selected according to the length of strip 133 stored in the spool 130. After the winding of the first layer 3, the pipeline wrapping apparatus 101 is returned to the starting position on the pipeline segment 4 and the second layer 2 is applied in a manner similar to the first layer 3. The helical winding of the second layer 2 may be offset by about half the pitch of the helical winding of the first layer 3. Additional layers may be added to continue to add to the wall thickness of the pipeline segment 4 as desired. In another embodiment, the pipeline wrapping apparatus 101 may include a second winding head in order to provide the second layer after the first layer as the pipeline wrapping apparatus 101 is axially translated along the pipeline segment 4.

After the layer(s) are added to the pipeline segment 4, the pipeline wrapping apparatus 101 may be lifted back onto the trailer to be deployed at another location. If the length of pipeline segment 4 to be reinforced exceeds the length of strip provided by the spool, the pipeline wrapping apparatus may be positioned at the ending point of the prior wrapping location to begin the wrapping process again. The trailer may be relocated as necessary to continue the wrapping process.

In another embodiment, a protective outer layer may be applied to the pipeline after wrapping the layer(s) as described above. The protective outer layer may be, for example, liquid epoxy or urethane. The protective outer layer may be applied using a separate pipeline coating unit, or by adding a pipeline coating module to the pipeline wrapping apparatus that resembles the oscillating adhesive assembly 401 described above. The pipeline coating module may be attached to the pipeline wrapping apparatus on the opposite side of the winding head 301 from the oscillating adhesive assembly 401 so that the pipeline coating module passes over the pipeline segment 4 after the winding head 301 applies the layer(s) 2, 3 for reinforcing the pipeline segment 4. The material for the protective outer layer may be provided using a tank on the pipeline wrapping apparatus or by a separate tank connected to the pipeline coating module by a hose. The separate tank may be placed on the trailer. The tank and the hose may be heated to prevent the material from solidifying prior to application or to assist with cross-linking.

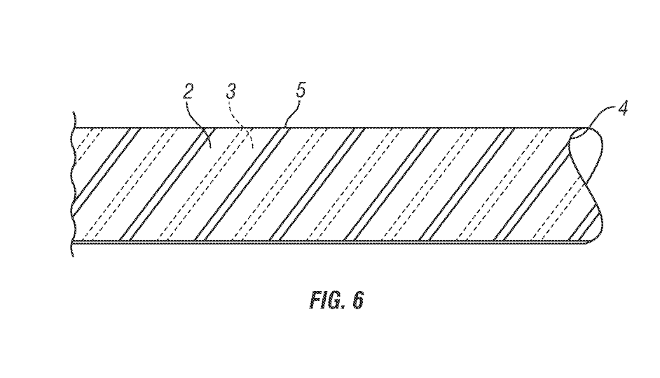

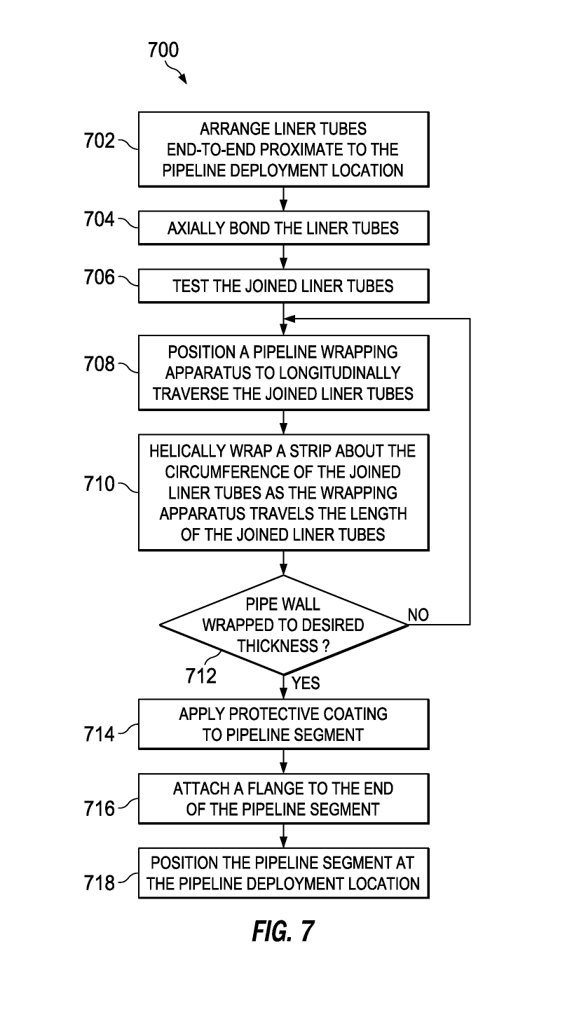

FIG. 7 shows a flow diagram for a method 700 for manufacturing a composite pipeline near the location of final installation of the pipeline in accordance with various embodiments. In block 702, sections of liner tube 802 are transported to a location at or near to the location where the location where the pipeline is to be finally installed. The lengths of tubing are arranged end-to-end, and may be positioned on support platforms 804 as shown, for example, in FIG. 8. A positioning apparatus, such as a crane, may be used to arrange the tubes. The support platforms 804 may be disposed adjacent to a trench 806 in which the pipeline is to be finally installed. The support platforms 804 may include rollers allowing the liner tubes 802 to be moved axially after being positioned thereon. In some embodiments, the sections of liner tube 802 and the associated support platforms 804 may be positioned in the trench 806 allowing composite pipe construction in the trench 806, and eliminating repositioning of the pipeline into the trench after construction.

The liner tubes 802 may have substantially thinner walls and therefore be substantially lighter than conventional steel pipe. For example, a 42 inch liner tube may be constructed with a 3 millimeter (“mm”) thick stainless or carbon steel wall rather the much thicker wall of conventional steel pipe. Sections of the liner tube 802 have a wall thickness that is a fraction of the wall thickness required by a pipeline configured for a given application. For example, the American Petroleum Institute 5L standard may require 42 inch outside diameter line pipe to have a nominal wall thickness of up to 1.25 inches, while the liner tube 802 may have a wall thickness of only a few millimeters. Thus, some embodiments of the liner tube 802 function as a fluid barrier rather than a pressure barrier. Various embodiments of the liner tube 802 have sufficient strength to withstand the force of the tracks 404 of the wrapping apparatus, and at least some embodiments have sufficient strength to bear the weight of the wrapping apparatus during the pipeline manufacturing operation.

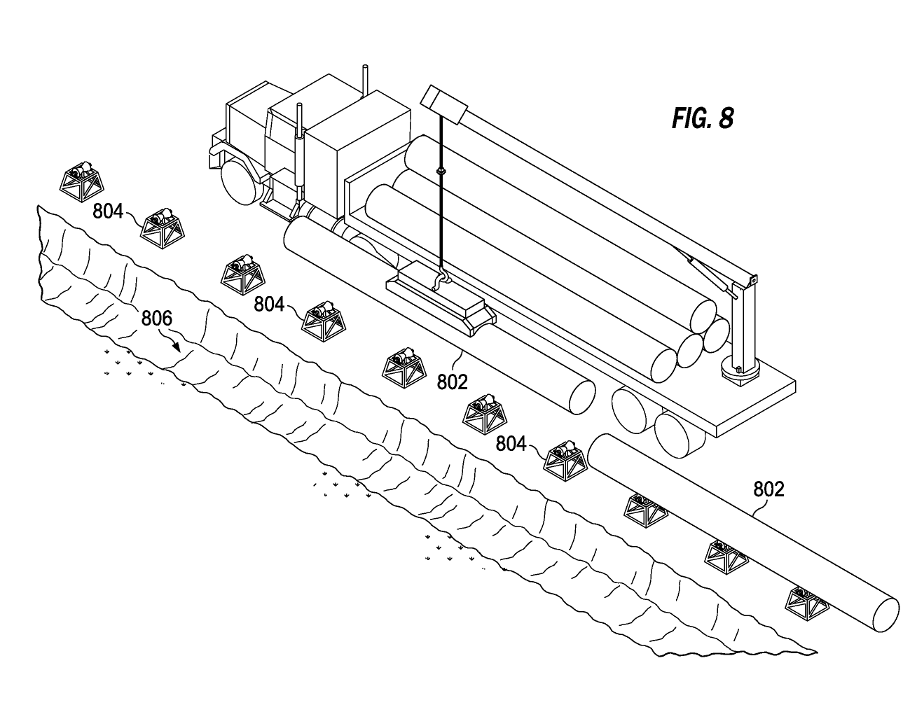

In block 704, the liner tubes 802 are positioned end-to-end and the tubes 802 are axially bonded to one another. The rollers of the support platforms allow the tubes 802 to be longitudinally repositioned to facilitate bonding. In various embodiments, the tubes 802 may be bonded using a bonding or joining apparatus, such as a welder. In some embodiments, an orbital welder 902 can be used to bond the tubes in a single pass. In this fashion, a liner tube of indefinite length can be formed. FIG. 9 shows a welding crew traversing the liner tubes 802, and employing an orbital welder 902 to bond the tubes 802 into a tubing segment. The welds can be ultrasonically tested, and the completed tubing segment can pneumatically and/or hydraulically pressure tested as a unit in block 706.

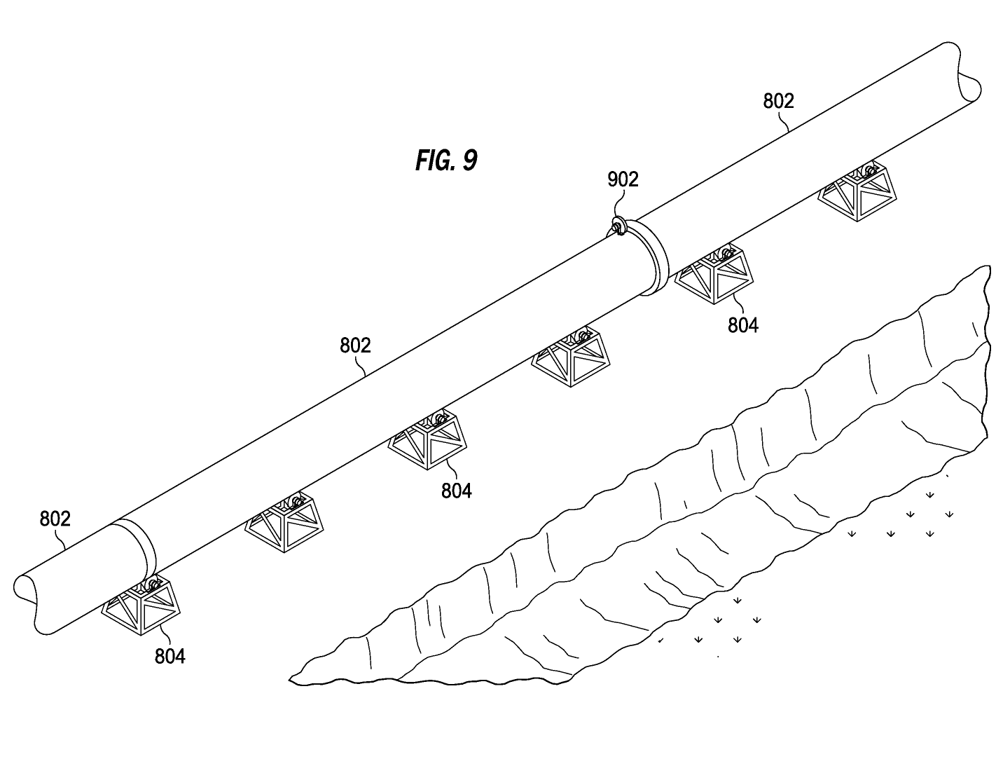

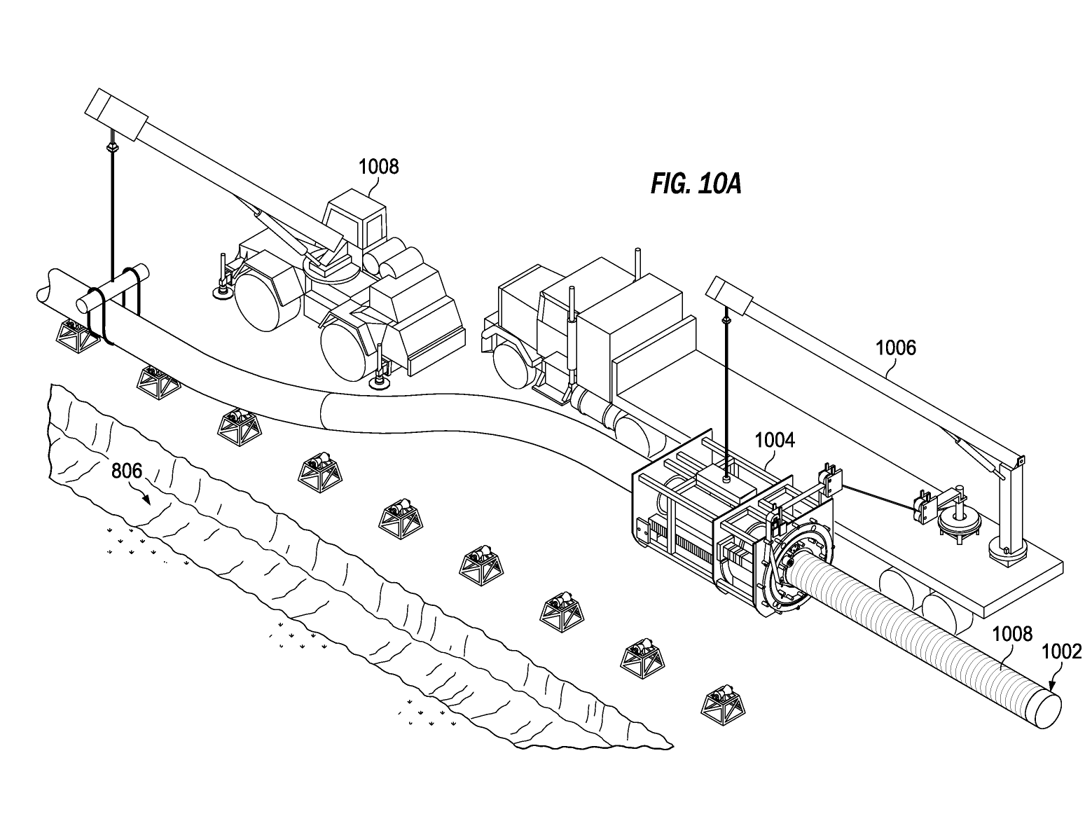

In block 708, the tubing segment 1002 is complete and ready to receive material to reinforce the wall of the pipeline segment. A pipeline wrapping apparatus 1004 (shown in FIG. 10A) is positioned about the tubing segment 1002 at a first end of the tubing segment 1002. A side boom or other crane apparatus 1008 may be used to elevate a portion of the tubing segment as the wrapping apparatus 1004 is positioned about and longitudinally traverses the tubing segment 1002. As further explained above, the wrapping apparatus 1004 may include a removable section that is separated from the wrapping apparatus 1004 to allow positioning of the wrapping apparatus 1004 about the circumference of the tubing segment 1002. After the wrapping apparatus 1004 is positioned about the tubing segment 1002, the removable portion is rejoined to the wrapping apparatus 1002 to allow the wrapping apparatus 1002 to fully surround the tubing segment 1004.

In block 710, the wrapping apparatus 1004 propels itself along the tubing segment 1002 from the first end to a second end, and helically wraps strip material 1008 around the circumference of the tubing segment 1002. Thus, the wrapping apparatus is a coiling mechanism that winds the strip material around the tubing segment 1002 in a three-dimensional spiral. The strip material 1008 may be fed from a spool located on the wrapping apparatus and/or located on a vehicle that moves along the tubing segment 1002 in conjunction with the wrapping apparatus 1004. The strip material may be stainless steel or another material as explained above. The wrapping apparatus 1004 may also apply an adhesive material prior to applying the strip material 1008. Some embodiments of the wrapping apparatus 1004 can wrap multiple layers of strip material in a single pass along the tubing segment 1002. FIG. 10A shows the wrapping apparatus 1004 positioned on the tubing segment 1002 and helically wrapping strip material 1008 around the tubing segment 1002 as the wrapping apparatus 1004 advances to manufacture a composite pipeline segment.

In some embodiments, the tubing segment 1002 may bear the weight of the wrapping apparatus 1004 as the wrapping apparatus 1004 traverses the tubing segment 1002. In other embodiments, a boom or other crane apparatus 1006 supports the wrapping apparatus 1004 as the wrapping apparatus 1004 moves along the tubing segment 1002, thereby relieving the tubing segment 1002 of such a support requirement. As shown in FIG. 10B, yet other embodiments include a rail system 1010 that supports the wrapping apparatus 1006 during composite pipeline manufacturing operations. The rail system 1010 may include a number of rail segments 1012. The rail segments 1012 are moveable, allowing a segment 1012 that the wrapping apparatus 1004 has moved past to be repositioned ahead of the wrapping apparatus 1004. Various embodiments of the rail system may include different numbers and/or locations of rails relative to the wrapping apparatus 1004. For example, an embodiment may include rails disposed on either side of the wrapping apparatus 1004.

The wrapping apparatus 1004 may be positioned to traverse the tubing segment 1002 as many times as is needed to build the wall of the composite pipeline segment to a desired thickness. In block 712, whether the wall has been built to the desired thickness by the wrapping 1008 is determined. If the wall is thinner than desired, the wrapping apparatus 1004 is positioned, in block 708, to make another pass along the pipeline segment and wind an overlapping strip of material about the pipeline segment. Strip materials of different composition may be wound onto the pipeline segment on different passes and/or the same pass. If the wall is found to be of at least the desired thickness, then, in some embodiments, the wrapping apparatus 1004 is positioned to traverse the pipeline segment and wrap an outermost strip that is FBE coated around the pipeline segment. In some embodiments, the number of passes required to build the pipeline segment wall to a desired thickness is predetermined.

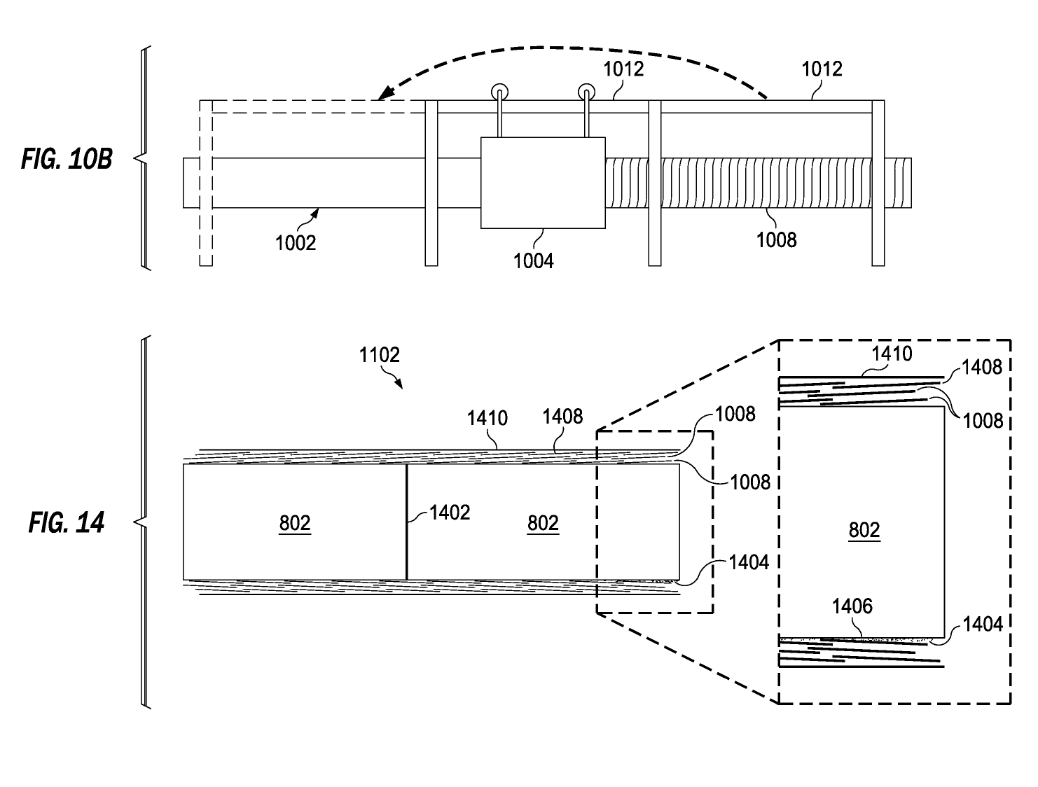

In block 714, the walls of the pipeline segment 1102 have been built to the desired thickness, and a protective coating 1104 (e.g., a sealing layer) is applied to the pipeline segment 1102 as a rock and/or moisture barrier. The protective coating 1102 may be, for example, an epoxy or urethane coating. In some embodiments, a coating apparatus 1106 may be positioned on the pipeline segment 1102 to apply the protective coating 1104 to the entire pipeline segment 1102 in a single pass as the coating apparatus 1106 traverses the pipeline segment 1102 as shown in FIG. 11.

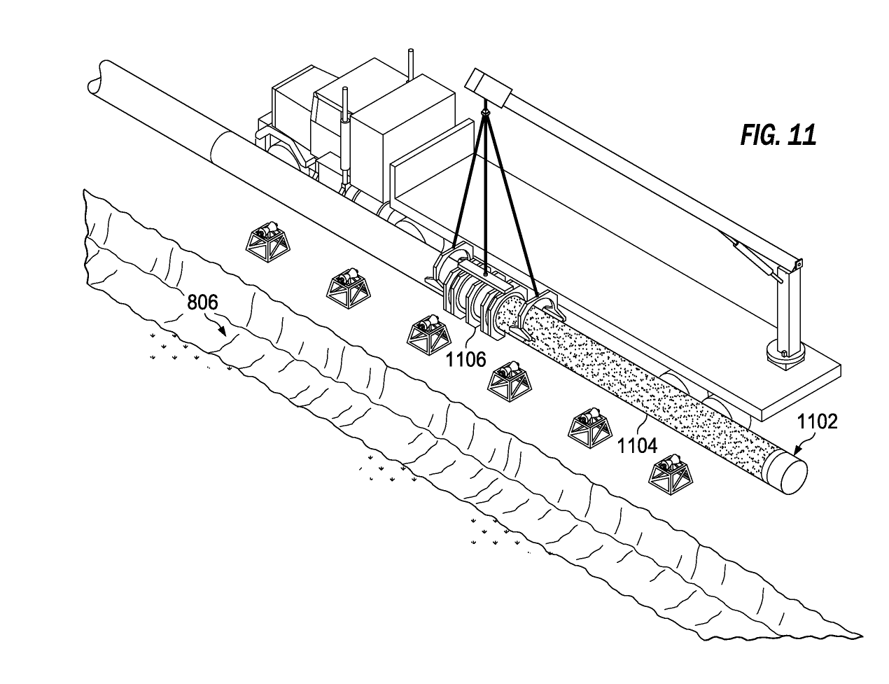

In block 716, the pipeline segment 1102 has been fully coated and tapered corrosion resistant alloy or stainless steel ends 1202 are bonded to a portion of the pipeline segment 1102 that remains unwrapped. The bonding may be by welding. The tapered end 1202 is overwrapped with the same strip materials 1008 as the wall of the pipeline segment 1102. FIG. 12 shows a view of a tapered end 1202 bonded to the pipeline segment 1102.

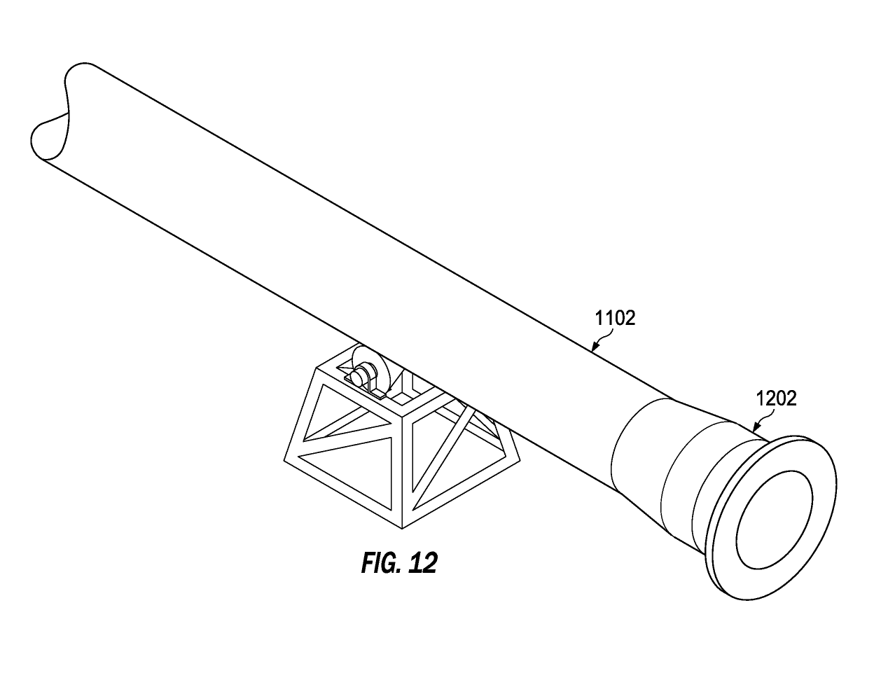

In block 718, the on-site manufactured composite pipeline segment 1102 is positioned at the pipeline deployment location 806. For example, a side boom 1008 may lower the composite pipeline segment 1102 into the trench 806 as shown in FIG. 13.

A composite pipeline segment 1102 may constructed in accordance with the method 700 to be of any length by adding liner tubes 802 and wrapping as described above. Consequently, connections are added only at tie in locations, for crossings, equipment connections, etc.

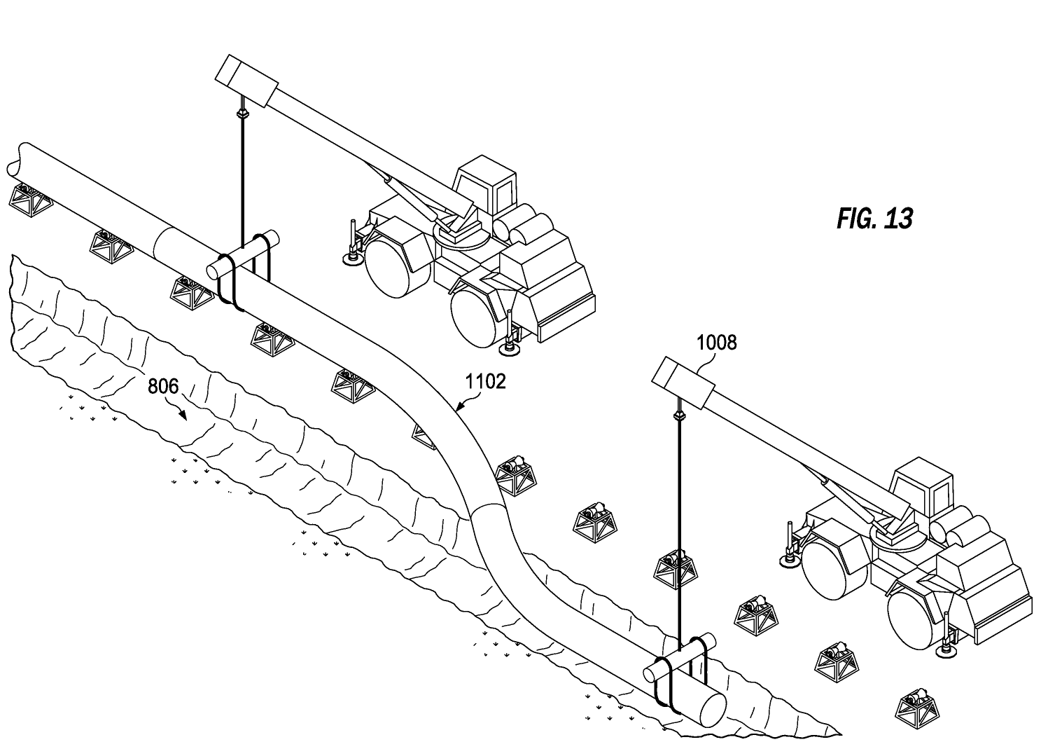

FIG. 14 shows a longitudinal cross-section of a composite pipe segment 1102 constructed in accordance with various embodiments. The pipe segment 1102 includes liner tubes 802 bonded together at joint 1402. The liner tubes 802 are light weight (e.g., 3 mm wall thickness) relative to conventional steel pipe, thereby facilitating transport and handling. Though only two liner tubes 802 are shown, in practice, the pipe segment 1102 may include two or more liner tubes 802. Strips of material (e.g., ultra high-strength steel) 1008 are helically wrapped around the joined liner tubes 802. Each of the strips of material 1008 comprises a single piece of material wrapped around the pipe segment 1102 from end to end. Adhesive 1404 may be applied between the wall 1406 of the liner tubes 802 and the strip of material 1008 and between each two strips of material (e.g., between strips 1008, and between strips 1008 and 1408. Strips of material 1008 are wound around the liner tubes 802 until a desired wall thickness is achieved. An outermost strip of material 1408 wrapped about the pipeline segment 1102 may include an FBE coating. A protective coating 1410 (e.g., liquid epoxy, urethane, etc.) may be applied to the outermost strip 1408 as a rock or moisture barrier.

While specific embodiments have been shown and described, modifications can be made by one skilled in the art without departing from the spirit or teaching of this invention. The embodiments as described are exemplary only and are not limiting. Many variations and modifications are possible and are within the scope of the invention. Accordingly, the scope of protection is not limited to the embodiments described, but is only limited by the claims that follow, the scope of which shall include all equivalents of the subject matter of the claims.

What is claimed is:

1. A method for constructing a pipeline, comprising:
arranging a plurality of sections of tubing proximate to a location where the pipeline is to be deployed, wherein an end of a first of the sections of tubing axially abuts an end of a second of the sections of tubing;
joining the abutting ends of the first and second of the sections of tubing;
wrapping, in a helical pattern, a continuous strip of material over the length of the joined first and second of the sections of tubing to form a pipeline segment.

2. The method of claim 1, further comprising:
positioning a pipeline wrapping apparatus on the joined first and second of the sections of tubing;
wherein the wrapping comprises winding the strip of material about the sections of tubing as the wrapping apparatus longitudinally traverses the joined first and second of the sections of tubing.

3. The method of claim 2, wherein the wrapping apparatus propels itself longitudinally along the joined first and second of the sections of tubing.

4. The method of claim 1, wherein the plurality of sections of tubing comprise more than two sections of tubing.

5. The method of claim 1, further comprising:
providing a rail system along the sections of tubing; and
bearing, by the rail system, a pipeline wrapping apparatus circumferentially disposed about the sections of tubing to perform the wrapping.

6. The method of claim 5, further comprising repositioning a portion of the rail system to a location along the sections of tubing ahead of the pipeline wrapping apparatus after the pipeline wrapping apparatus traverses the portion of the rail system.

7. The method of claim 1, further comprising joining a tapered end to an end of the pipeline segment, and helically wrapping the tapered end with a strip of material.

8. The method of claim 1, further comprising aligning tracks of a pipeline wrapping apparatus at an angle oblique to the axis of the sections of tubing thereby counteracting torque induced in the wrapping apparatus by the winding of the strip of material about the sections of tubing.

9. The method of claim 1, wherein the arranging comprises positioning the sections of tubing in a trench where the pipeline is to be deployed.

10. A system for constructing a pipeline, comprising:
a positioning apparatus configured to arrange a plurality of sections of liner tubing end-to-end proximate to a location of deployment of the pipeline;
a joining apparatus configured to axially bond the sections of liner tubing into a tubing segment;
a wrapping apparatus configured to helically wrap a strip of material around the joined sections of tubing to form a pipeline segment;
wherein the wrapping apparatus is configured to increase thickness of a circumferential wall of the pipeline segment while moving longitudinally along the pipeline segment.

11. The pipeline construction system of claim 10, further comprising a rail system disposed along the pipeline segment, wherein the rail system is configured to bear the weight of the wrapping apparatus as the wrapping apparatus moves along the pipeline segment.

12. The pipeline construction system of claim 11, wherein the rail system comprises a plurality of rail sections, each section configured to be removed from the rail system behind the wrapping apparatus, and added to the rail system ahead of the wrapping apparatus.

13. The pipeline construction system of claim 10, wherein the wrapping apparatus is configured to simultaneously wrap a steel strip and a fusion bonded epoxy coated strip of material around the pipeline segment.

14. The pipeline construction system of claim 10, wherein the wrapping apparatus is configured to propel itself along the tubing segment and to control thereby an angle of wrapping.

15. The pipeline construction system of claim 10, wherein the wrapping apparatus is configured maintain a rotational position on the tubing segment by counteracting rotational forces on the apparatus generated by the wrapping.

16. The pipeline construction system of claim 10, further comprising a plurality of support members configured to elevate the sections of liner tubing and to permit axial movement of the sections of liner tubing while disposed on the support members.

17. An on-site manufactured composite pipeline, comprising:
a plurality of liner tubes welded together end-to-end to form a tubing segment; and
a first continuous strip of material, helically wrapped around the plurality of liner tubes, wherein the first strip of material increases the burst strength of the tubing segment.

18. The pipeline of claim 17, wherein a wall of the liner tubes is less than 4 millimeters thick.

19. The pipeline of claim 17, wherein a first strip of material is wrapped “adjacent to” the liner tubes and a second strip of material overlays the first strip of material.

20. The pipeline of claim 17, further comprising a tapered end welded to an end of the tubing segment, and wherein the tapered end is helically wrapped with one or more strips of material corresponding in type and number to strips of material wrapped around the plurality of liner tubes.
